(19) United States
(12) Patent Application Publication
(10) Pub. No.: US 2023/0146009 A1
(43) Pub. Date: May 11, 2023

(54) Molded Parts for Low Temperature Applications, Especially for Liquid Hydrogen

(71) Applicant: Japan Silicolloy Industry Co., Ltd., Ako-gun (JP)

(72) Inventors: Takayasu Shimizu, Ako-gun (JP); Hiroyuki Shimizu, Ako-gun (JP)

(21) Appl. No.: 17/985,688

(22) Filed: Nov. 11, 2022

(30) Foreign Application Priority Data
Nov. 11, 2021 (DE) 102021129414.2

(51) Int. Cl. C21D 9/00; C21D 6/00; C22C 38/52; C22C 38/44; C22C 38/34; C22C 38/42; C22C 38/04; C22C 38/00; C22C 38/06; C22C 38/46

(52) U.S. Cl. CPC C21D 9/0068; C21D 6/007; C21D 6/008; C21D 6/005; C21D 6/004; C22C 38/52; C22C 38/44; C22C 38/34; C22C 38/42; C22C 38/04; C22C 38/004; C22C 38/002; C22C 38/06; C22C 38/46; C21D 2211/001; C21D 2211/005; C22C 2202/02

(57) ABSTRACT

Method of producing cast-steel molded parts especially suited to low-temperature applications, particularly, handling liquid hydrogen. Conventional high-nickel alloy austenitic stainless steels must be used as forged, not cast, products with high wall thicknesses to lend them the mechanical properties sufficient for handling liquid hydrogen and preventing hydrogen embrittlement. According to the method, an alloy consisting essentially of 2.5-4.5% Si, 10.5-19.0% Cr, 13.5-20.0% Ni, 0.5-1.5% Mn, 1.0-2.0% Co, and 0.5-1.5% Mo is melted; the melt is poured into a mold; and the molded part is solution heat-treated at a temperature of from 950° C. to 1150° C. The cast steel parts have a high content of hydrogen-embrittlement curtailing silicon, and nickel, chromium and other components lending them properties not essentially due to the conventional-steel presence of carbon. The molded parts thus produced have sufficient fracture toughness even at liquid-hydrogen temperatures.

### BACKGROUND OF THE INVENTION

### Technical Field

The present invention relates to a method for the production of molded parts, and the molded parts themselves. Furthermore, the use of the molded parts in low-temperature applications is part of the present application. The present invention relates to a molded body made of stainless steel with a high silicon content, which can be produced by casting and used with liquid hydrogen (−253° C.).

### Description of the Related Art

The discussion concerning global warming through carbon dioxide emissions has led to increased interest in new forms of energy generation and energy storage. One of the forms of energy storage that is being considered is the storage of energy in the form of hydrogen. Hydrogen can be obtained by electrolysis of water or from hydrocarbons. Its energy can be used, for example, by combustion and in fuel cells. The storage of hydrogen is one of the challenges that arise in the further development of hydrogen technology. Because of its low density, hydrogen can only be stored in large quantities under high pressure or as a liquid. Liquid hydrogen is stored at around −253° C. Materials that are used in plants for the storage or use of liquid hydrogen must therefore have the necessary mechanical properties at these temperatures. Critical parameters include the yield strength, tensile strength, elongation at break, reduction in area, hardness and toughness and especially the fracture toughness at −253° C.

For applications with liquid hydrogen conventional high-alloy austenitic stainless steels have been used for decades, such as SUS 304 with a content of about 8 to 10.50 percent by weight nickel and about 18 to 20 percent by weight chromium. High levels of nickel promote strength and prevent the steel from becoming brittle due to hydrogen. Stainless steels such as SUS 316 and SUS 316L are more suitable. These additionally contain molybdenum, which further reduces embrittlement and improves toughness. However, as a rule, all of these steels have to be used as forged products with high wall thicknesses because their physical properties, in particular their hardness, are insufficient. Some steels specially developed for use with liquid hydrogen contain nickel in amounts of 12 percent by weight and more. JP 2018-104793 A describes austenitic steel with 12.5 to 15.4 percent by weight nickel and less than 1 percent by weight chromium, which is stated to be particularly suitable for tanks for liquid hydrogen. Corresponding steel variants with chromium amounts of 21.5 to 23.5 percent by weight for use in piping for liquid hydrogen are also known under the trade name HRX19. A problem with all of these steels, however, is that only forging can provide them with properties that make them suitable for use with liquid hydrogen. As cast steels, they have insufficient hardness and/or insufficient fracture toughness. Therefore, molded parts for valves or the like cast therefrom have a short service life. The production of such shaped parts from forged parts by ablative methods is however laborious. Such methods are hardly suitable for mass production. There is therefore a need to further develop hydrogen technology in this point.

### BRIEF SUMMARY OF THE INVENTION

It is an object of the present invention to provide cast molded steel parts which are suitable for low-temperature applications. In particular, these should be suitable for applications with liquid hydrogen. The cast molded parts can be valves or parts thereof. The molded parts should have sufficient hardness and sufficient fracture toughness at −253° C.

The present invention in one aspect is a method for producing molded parts comprising the following steps:
(a) melting an alloy consisting of:

| | | | |
|---|---|---|---|
| Si: | 2.50 | to | 4.50%, |
| Cr: | 10.50 | to | 19.00%, |
| Ni: | 13.50 | to | 20.00%, |
| Mn: | 0.50 | to | 1.50%, |
| Co: | 1.00 | to | 2.00%, |
| Mo: | 0.50 | to | 1.50%, |

and the rest are iron and inevitable impurities, the contents of C, P, S and Cu as inevitable impurities are as follows:
C: not more than 0.050%,
P: not more than 0.030%,
S: not more than 0.030%,
Cu: not more than 1.50%,
   where all quantities are given in percent by weight based on the total mass of the alloy;
(b) pouring the melt into a mold; and
(c) subsequently carrying out a solution heat treatment of the molded parts at a temperature in the range from 950° C. to 1150° C.

In this description, all data in % relate to the proportion of the respective element in the total alloy in percent by weight.

The stainless steel SUS316L is currently used as a standard material for liquid hydrogen. The present invention demonstrates that high silicon stainless steel, which has strength, low temperature toughness, hardness, corrosion resistance, and good abrasion properties, is suitable for use with liquid hydrogen. The present invention makes it possible to use cast steel instead of forged steel. The steel of the present invention contains 2.50 to 4.50% silicon, 10.50 to 19.00% chromium and 13.50 to 20.00% nickel as essential components. It is a stainless steel with high silicon content. Structure and properties are therefore not essentially due to the presence of carbon, as is the case with conventional steel, but to the high proportion of silicon.

### Silicon

The steel of the present invention contains a large amount of Si. The Si creates a specific metallographic structure that gives the steel strength. This makes carbon unnecessary. Si also provides the steel with high fracture toughness at −253° C., oxidation resistance, corrosion resistance, heat resistance and high-temperatures softening resistance. Si also lowers the melting point of the steel, increases its flowability and thereby improves castability. If its content is below 2.5%, its effect on the above properties is insufficient. A higher content of silicon increases the castability of the melt and leads to more balanced properties of the molded body obtained. The silicon content is therefore preferably at least 3.0%, more preferably at least 3.3% and particularly preferably at least 3.5%. A lower limit of 3.7% is most preferred. On the other hand, since Si is a strong ferrite-forming element, too much of it disturbs the basic structural balance of the steel. The upper limit is therefore set at 4.5%. However, if high fracture toughness of the alloy at −253° C. is desired, the silicon content preferably does not exceed 3.5%, and particularly preferably does not exceed 3.0%. Most preferably, the silicon content ranges from 2.5 to 2.9%.

### Chromium

Chromium is a component for ensuring the basic properties, namely corrosion resistance (especially resistance to embrittlement by hydrogen), heat resistance and oxidation resistance, of the stainless steel according to the invention. In combination with nickel, chromium provides the desired structure of the steel matrix (one-phase structure consisting of austenite or two-phase structure consisting of austenite and ferrite) and thus the desired properties. Chromium also counteracts the embrittlement caused by hydrogen. If the chromium content is less than 10.50%, the effect against embrittlement due to hydrogen is too low. A content of at least 17.00% is preferred in order to obtain a good metallographic structure and to increase the effect against embrittlement by hydrogen. When the chromium contents exceed 19.00%, the chromium equivalent defined below becomes large and the austenite content increases. It thus becomes difficult to obtain the desired mechanical properties. However, in some processes of the present invention, it is preferred to keep the amount of chromium below 15% in order to obtain alloys with high fracture toughness at −253° C.

### Nickel

Nickel provides the steel with good low-temperature toughness, corrosion resistance, oxidation resistance and heat resistance and is also an element that provides the desired structure of the steel matrix (one-phase structure consisting of austenite or two-phase structure consisting of austenite and ferrite) in combination with Cr. Nickel in particular has a significant influence on the notched impact strength at ultra-low temperatures. In order to achieve a high notched impact strength at around −253° C., a content in the range from 13.50% to 20.00% is required. A nickel content in the range from 13.50 to 18.00% is preferred, a content in the range of from 13.50 to 15.00% is especially preferred and a content in the range of from 13.50 to 14.50% is most preferred. However, like silicon and chromium, nickel also makes the alloy highly resistant to hydrogen embrittlement. For this purpose it is desirably that nickel is present in large amounts. Especially if only small amounts of silicon and chromium are used, the nickel content is preferably in the range from 14 to 20%, especially in the range from 15 to 20%.

### Manganese, Cobalt and Molybdenum

The alloy of the present invention further contains manganese, cobalt and molybdenum in small amounts. Manganese serves as a deoxidizing agent and is at the same time an austenite-forming element and counteracts the embrittlement caused by hydrogen. If the proportions are too high, however, it reduces the corrosion resistance and has a negative influence on the mechanical properties. The proportion of manganese is therefore in the range from 0.50 to 1.50%. Cobalt is also an element that promotes austenite formation. It also increases strength (hardness) and corrosion resistance. These effects become significant at 0.50% and above and increase with increasing content. Cobalt is expensive, however. Therefore, it is present in the range 1.00 to 2.00%. Molybdenum helps improve toughness and wear resistance. It also increases the corrosion resistance of steel as well as its strength at elevated temperatures. In order to sufficiently ensure these effects, a content of not less than 0.50% is desirable. On the other hand, since it is a ferrite-forming element, excessive amounts lead to an undesirable structure of the steel. In addition, Molybdenum is expensive. Therefore, the Molybdenum content should not be more than 1.50%.

### Impurities

Carbon, phosphorus, sulfur, and copper have a negative influence on the properties of the alloy of the present invention, and they are preferably not included therein. However, they are often introduced into alloys due to an unavoidable content in commercially available metals. Their amounts must be kept within tight limits.

Carbon is an element that increases the strength of steel, and in general, high-strength steels contain a certain amount of carbon as an essential component. The present invention contains a large amount of silicon, which makes the use of carbon unnecessary and undesirable. Carbon lowers the toughness of the steel and adversely affects its machinability, oxidation resistance and corrosion resistance. Therefore, the carbon content should be as low as possible. The amount of carbon in the alloy of the present invention should not exceed 0.050%; preferably it should not exceed 0.030%. Especially preferred is a carbon content of 0.020% and below and most preferred is a carbon content of 0.010% and below.

Phosphorous is a typical harmful impurity in stainless steel. It segregates in steel and deteriorates the mechanical properties, the machinability and the corrosion resistance. Therefore, its content should be limited to 0.030% and should be reduced to the lowest possible level. Preferred are 0.015% and most preferred are 0.010%.

Sulfur is also a harmful contaminant. It causes the red shortness of steel and thereby reduces the hot machinability of steel. It impairs the cleanliness of the steel due to sulfide inclusions and deteriorates the mechanical properties such as fatigue strength and cursing strength etc. It also reduces corrosion resistance. Therefore, the content of sulfur should be limited to 0.030%, preferably the content should not exceed 0.020%, most preferably and especially in the case of a steel intended for the production of thin wires with a diameter of not larger than 0.1 mm the sulfur content should be limited to 0.005% or less.

Copper is often introduced into alloys through recycled steel and other ingredients. It affects the hot formability of steel. It also reduces toughness at −253° C. The negative influence of copper is relatively small up to an amount of 1.5%. The present alloy should therefore contain no more than 1.5% copper, preferably no more than 1.0%, particularly preferably no more than 0.70%, very particularly preferably no more than 0.30%. The alloy used in the present process can further contain aluminum, tungsten, nitrogen, oxygen, or hydrogen as unavoidable impurities. The alloy used in the present process comprises preferably not more than 0.01% aluminum, not more than 0.5% of tungsten, not more than 0.03% nitrogen, not more than 0.002% oxygen and not more than 0.0002% hydrogen.

### Hydrogen Embrittlement

The alloy used in the present process is particularly suitable for molded parts that are intended for use with liquid hydrogen. Hydrogen causes hydrogen embrittlement in conventional steels. In the present alloy, however, hydrogen embrittlement is suppressed by a high content of silicon, nickel, chromium and other alloy components. The ability of the elements contained in the alloy to suppress hydrogen embrittlement is expressed by a nickel equivalent yH. The alloy that is used in the process according to the invention preferably has a nickel equivalent yH of at least 24%, where the nickel equivalent yH is calculated according to the formula (1):

yH=0.35*Si (%)+0.65*Cr (%)+1.0*Ni (%)+1.05*Mn (%)+0.98*Mo (%)+12.6*C (%), (1)

where Si (%), Cr (%), Ni (%), Mn (%), Mo (%) and C (%) mean the content of these elements in the alloy in percent by weight, each based on the total amount of the alloy. The alloys according to the invention preferably have a nickel equivalent yH of at least 26.9%. Particularly preferred are those alloys whose nickel equivalent is at least 28.5%. They are practically not affected by hydrogen embrittlement. Most preferably the nickel equivalent is at least 29%.

### BRIEF DESCRIPTION OF THE DRAWING

The FIGURE shows the metallographic structure of the steel according to the invention.

### DETAILED DESCRIPTION OF THE INVENTION

In a preferred embodiment of the method according to the invention, the alloy has the following composition:

| | | | |
|---|---|---|---|
| Si: | 3.70 | to | 4.50%, |
| Cr: | 17.00 | to | 19.00%, |
| Ni: | 13.50 | to | 14.50%, |
| Mn: | 0.50 | to | 1.50%, |
| Co: | 1.00 | to | 2.00%, |
| Mo: | 0.50 | to | 1.50%, |

and the rest are iron and inevitable impurities, the contents of C, P, S and Cu as inevitable impurities are as follows:
C: not more than 0.030%,
P: not more than 0.030%,
S: not more than 0.030% and
Cu: not more than 1.00%,
   where all quantities are given in percent by weight based on the total mass of the alloy. Such an alloy has a nickel equivalent yH of at least 26.9 and is therefore particularly preferred for applications with hydrogen. Even more preferred is an alloy of such a composition with a nickel equivalent yH of at least 28.5% and most preferred is an alloy of such a composition with a nickel equivalent yH of at least 29%. In a further preferred embodiment of the method according to the invention, the alloy has the following composition:

| | | | |
|---|---|---|---|
| Si: | 2.50 | to | 3.50%, |
| Cr: | 10.50 | to | 19.00%, |
| Ni: | 13.50 | to | 20.00%, |
| Mn: | 0.50 | to | 1.50%, |
| Co: | 1.00 | to | 2.00%, |
| Mo: | 0.50 | to | 1.50%, |

and the rest are iron and inevitable impurities, the contents of C, P, S and Cu as inevitable impurities are as follows:
C: not more than 0.050%,
P: not more than 0.030%,
S: not more than 0.030% and
Cu: not more than 1.50%,
   where all quantities are given in percent by weight based on the total mass of the alloy. Such alloys have high fracture toughness and low hydrogen embrittlement. This is especially true if in this alloy the amount of chromium is less than 15% and the amount of nickel is more than 14%, especially more than 15%. Also in this embodiment, it is preferred that the carbon content is 0.030% or less and the copper content is 1.00% or less.

In the present process, the casting is preferably carried out under protective gas and, moreover, preferably according to known procedures with the usual protective devices.

### Solution Heat Treatment

The solution heat treatment at a temperature of 1050 to 1150° C. provides the molded parts according to the invention a one-phase structure comprising fine austenite or a two-phase structure comprising fine austenite and ferrite. The molded parts are thus provided with the necessary hardness and overall improved other mechanical properties. This structure provides the molded parts with a high degree of fracture toughness at the lowest temperatures, in particular at −253° C. and is particularly resistant to hydrogen embrittlement. At temperatures below 950° C., the mixed crystal formation is insufficient and the residual austenite content is too high, which counteracts the increase in strength. On the other hand, at temperatures over 1150° C., the crystal grains become coarse and the toughness decreases. The solution heat treatment usually has the best effects at a temperature in the range from 1050 to 1150° C. It is therefore preferred that the solution treatment is carried out in this temperature range. The temperature ranges for from 950 to 1150° C. and from 1050 to 1150° C. can be applied equally to all processes and all alloys of the present invention.

The duration of the solution heat treatment is usually 10 to 60 minutes, preferably 20 to 40 minutes. The best mechanical properties are obtained under these conditions. For larger molded parts, the duration of the heating can be estimated at 1 to 2 hours per inch of thickness of the molded parts. The optimal duration of the solution heat treatment may be determined on the basis of preliminary tests so that the desired properties, in particular the desired hardness and/or fracture toughness of the molded parts, are achieved.

The method for cooling after the solution heat treatment is not particularly limited. The cooling can take place, for example, by water cooling, oil cooling or gas cooling. Preferred are water cooling, oil cooling and cooling with liquid nitrogen. Particularly preferred is cooling with water. The molded parts can simply be immersed in water. Cooling to a temperature in the range of 10 to 50° C. is always sufficient. The temperature to which the molded parts must at least be cooled may be determined on the basis of preliminary tests. The temperature at which the properties have reached the necessary values is sufficient. Cooling with water, oil or gas is usually sufficient to achieve the necessary cooling rate. In the case of larger molded parts oil cooling or water cooling may become necessary. Immersion in water or oil with a temperature of 20° C. is usually sufficient to obtain the necessary cooling rate also for large molded parts. The necessary cooling rate can also be determined by preliminary tests.

Precipitation hardening is not necessary for the alloys used in the present invention.

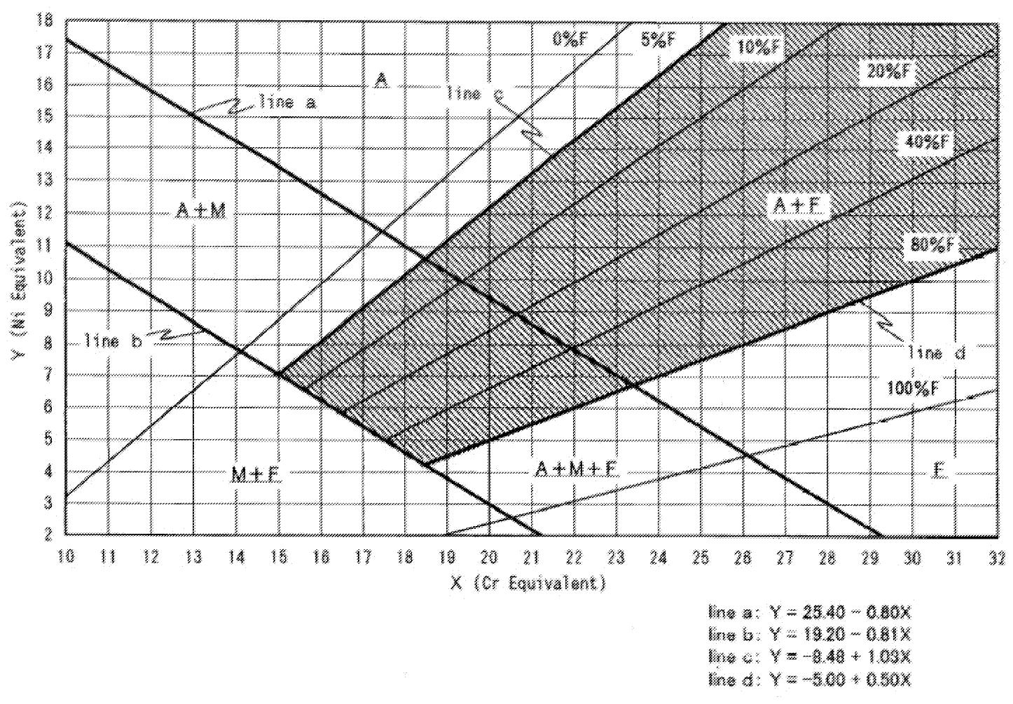

The FIGURE shows metallographic structures of alloys that are rich in silicon, nickel and chromium and after casting were subjected to a solution heat treatment of 1050° C. for 30 min and then subjected to water cooling. A nickel equivalent (Nieq) is plotted on the y-axis, according to the formula Nieq=Ni (%)+30*C (%)+0.5*Mn (%)+0.1*Co (%), where Ni (%), C (%), Mn (%) and Co (%) mean the content of these elements in the alloy in percent by weight, each based on the total amount of the alloy. A chromium equivalent (Creq) is plotted on the x-axis according to the formula Creq=Cr (%)+0.3*Mo (%)+1.5*Si (%)+0.5*Nb (%), in which Cr (%), Mo (%), Si (%) and Nb (%) mean the content of these elements in the alloy in percent by weight, each based on the total amount of the alloy. Niobium (Nb) can only be contained in the alloys according to the invention as an unavoidable impurity. As a rule, its content in the alloys according to the invention should be 0% or close to 0%. It has therefore no or almost not influence on the Creq-value. Depending on their composition, the alloys shown in the diagram contain austenite phases (A) and/or ferrite phases (F). The structure of the alloys used in the present invention is ideal if they are on or above line a and on or above line c in the diagram according to FIG. 1. Line a corresponds to the formula Nieq=25.40-0.80*Creq and line c corresponds to the formula Nieq=−8.48+1.03*Creq. A preferred method of the present invention is therefore characterized in that the composition of the alloy obeys the following conditions:

Nieq>=25.40−0.80*Creq (2)

Nieq>=−8.48+1.03*Creq (3)

Alloys that obey these conditions have a suitable fine structure, which provides the alloys with the necessary properties.

A particularly critical property of steels when used at low temperatures is the fracture toughness. Japanese regulations state that steels used for components in liquid hydrogen plants must have a fracture toughness of at least 27 J/cm². The fracture toughness for the purposes of this application is determined in accordance with a notched impact test according to George Charpy (Charpy impact strength). Cast parts made of steels conventionally used for such systems, such as SUS316L, cannot meet these requirements or only with a small safety margin. Molded parts that are cast from such steels, for example those that are used in valves, also have only a short service life, which requires frequent and costly maintenance of the systems they are used in. Therefore, complex shaped parts for such systems are often obtained from pieces of forged steel by abrasive methods. This is complex and leads to very large-volume parts. This causes high costs and is hardly suitable for mass production. Using the method according to the invention, molded parts can be produced by casting which still have sufficient fracture toughness even at very low temperatures. A method according to the invention is therefore preferred that is characterized in that the alloy has a fracture toughness of at least 27 J/cm², the fracture toughness being measured in accordance with JIS Z 2242 and at a temperature of −253° C., with a cuboid test specimen with a height of and width of 10 mm and a V-shaped notch of 2 mm, with the force acting on the opposite side of the notch. Molded parts of the present invention have particularly preferably a fracture toughness of at least 40 J/cm², very particularly preferably of at least 60 J/cm² and most preferably of at least 80 J/cm².

### Molded Parts

The molded parts produced in the process according to the invention can be any desired molded parts. The molded parts are preferably selected from the group consisting of valves, parts of valves, pumps, parts of pumps, turbines, parts of turbines, fittings, parts of fittings, pipes, distributors, connecting pieces, bolts, screws and nuts. Especially preferred they are valves or parts of valves. They are also preferably molded parts for use in systems in which liquid hydrogen is stored, transported or processed. For the purposes of the present invention, the plants in which liquid hydrogen is stored, transported or processed also include, in particular, pipelines, the related plants and other pipeline systems and hydrogen filling stations and the related plants. A method according to the invention is particularly preferred, which is characterized in that the molded parts produced therein are molded parts for use with liquid hydrogen.

Another object of the present invention are molded parts produced by the process according to the invention. The manufacturing process according to the invention for molded parts can be used in many ways. It makes all possible shapes accessible through casting, even in mass production. Since the alloy used in the present process contains a large proportion of silicon, the melt of these alloys has a very low viscosity. This makes it possible to cast very thin molded parts down to a thickness of only 1 mm. The molded parts according to the invention can be used in many ways, in particular for apparatuses which are used at low and extremely low temperatures. Since the steels used for the molded parts according to the invention also have high strength, the molded parts can also be used for apparatuses which are under high pressure. The present invention also relates to a valve which comprises or consists of a molded part of the present invention. The present invention also relates to a filling station for supplying vehicles with liquid hydrogen, comprising a molded part according to the invention, in particular comprising a valve which consists of or comprises a molded part according to the invention.

Another object of the present invention is the use of molded parts according to the invention, which is characterized in that at least a part of the molded parts has a temperature below −200° C. The use of the molded parts and/or valves according to the invention for storing or transporting liquid hydrogen is a preferred embodiment of the present invention. The use of molded parts according to the invention is likewise preferred, which is characterized in that at least a part of the molded parts is in contact with hydrogen. Particularly preferred is the use of molded parts which is characterized in that at least a part of the molded parts are in contact with liquid hydrogen. And most preferred is the use of molded parts which is characterized in that at least a part of the molded parts are in contact with liquid hydrogen, which has a temperature of −253° C. or less.

The use of the molded parts and/or valves according to the invention for storing or transporting liquid helium is a preferred embodiment of the present invention. Another preferred embodiment of the present invention is the use of molded parts according to the invention, which is characterized in that at least a part of the molded parts are in contact with liquid helium. Especially preferred is such a use, in which the helium has a temperature of −269° C. or less.

In many specialty applications, hydrogen embrittlement is a problem. The molded parts of the present invention are suitable for all such applications. For example, bolts for certain onshore wind turbines are made from the aluminum alloy SCM435. Here, hydrogen embrittlement is one of the problems that arise. Bolts produced according to the present process do not show any relevant hydrogen embrittlement. The use of bolts produced by the method according to the invention in wind power plants is therefore a further embodiment of the present invention.

### Examples

### Measurement Methods

Tensile testing: A round bar according to JIS No. 14A is subjected to a tensile test at 25° C. on a test machine according to JIS B 7721 according to JIS Z 2241:2011. Yield strength, tensile strength, elongation at break and reduction in area (after fracture) are determined. After measurement, the reduction in area is determined in accordance with JIS G 3199: 2009.

Hardness: Round bars with a diameter of 20 mm and a thickness of 10 mm were cast and, after mirror polishing, the hardness was determined on a Rockwell hardness tester.

Notched impact strength (fracture toughness): V-notched molded parts were produced in accordance with JIS No. 4A, and the Charpy impact strength was determined in accordance with JIS Z 2242 at 20° C., −196° C. and −253° C. using a testing machine in accordance with JIS B 7722. For measurements at −196° C., nitrogen was used for cooling. For measurements at −253° C., liquid helium was used for cooling. Block-shaped test specimens with a height and width of 10 mm and a V-shaped notch of 2 mm were used, the force acting on the opposite side of the notch. For the forged steels, forged parts were produced according to the same regulations and the Charpy impact strength was determined at −253° C. according to the same regulations with the same device.

### Preparation of Molded Parts

A number of molded parts were produced from 6 alloys according to the method according to the invention. The alloys were cast into the desired shape and cooled to 25° C. The solution heat treatment was then carried out at 1050° C. for 30 minutes. The molded parts were cooled to 25° C. by immersion in water. Tables 1a and 1b show the composition of the alloys.

TABLE 1a

Element

| Alloy No. | Si | Cr | Ni | Mn | Co | Mo |
|---|---|---|---|---|---|---|
| 1 | 2.79 | 10.7 | 14.6 | 0.93 | 1.50 | 0.97 |
| 2 | 2.85 | 12.0 | 14.5 | 0.84 | 1.50 | 0.90 |
| 3 | 2.87 | 13.2 | 14.6 | 0.91 | 1.50 | 0.89 |
| 4 | 3.00 | 14.4 | 16.9 | 0.91 | 1.50 | 0.89 |
| 5 | 2.96 | 12.6 | 15.7 | 0.93 | 1.50 | 0.90 |
| 6 | 2.99 | 18.0 | 12.1 | 0.97 | 1.50 | 1.40 |

TABLE 1b
(Continuation of Table 1a)

| | Element | | | | | | | |
|---|---|---|---|---|---|---|---|---|
| Alloy No. | C | P | S | Cu | Nb | V | Al | W |
| 1 | 0.003 | 0.02 | 0.01 | 0.59 | 0.20 | 0.04 | 0.004 | 0.030 |
| 2 | 0.006 | 0.02 | 0.01 | 0.57 | 0.20 | 0.05 | 0.004 | 0.022 |
| 3 | 0.047 | 0.02 | 0.01 | 0.58 | 0.17 | 0.04 | 0.004 | 0.029 |
| 4 | 0.010 | 0.02 | 0.02 | 0.55 | 0.18 | 0.05 | 0.004 | 0.027 |
| 5 | 0.003 | 0.02 | 0.01 | 0.57 | 0.20 | 0.05 | 0.005 | 0.021 |
| 6 | 0.023 | 0.03 | 0.01 | 0.26 | 0.02 | 0.07 | 0.002 | 0.602 |

All Elements of Table 1a are required elements for the present invention. All elements of Table 1 b are inevitable impurities, the presence of which is not necessary for the present invention. All values in Tables 1a and 1b are measured values, with the exception of the cobalt content. For Cobalt the weighed-in content is stated. The measurements were carried out with an ARL iSpark 8820 solid-state emission spectroscopy analyzer from ThermoFisher Scientific Inc., Waltham, Ma, USA.

### Mechanical Properties

The following Table 2 shows the results of the measurements of the Charpy impact strength in J/cm² at 20° C., −196° C. and −253° C. for the prepared molded parts. For comparison, the Charpy impact strength at −253° C. for the corresponding forged molded parts is shown.

TABLE 2
Charpy impact strength in [J/cm²]

| | Cast steel | | | Forged steel |
|---|---|---|---|---|
| Alloy No. | 20° C. | −196° C. | −253° C. | −253° C. |
| 1 | 258 | 126 | 105 | 173 |
| 2 | 200 | 104 | 60 | 224 |
| 3 | 244 | 125 | 98 | 176 |
| 4 | 146 | 139 | 44 | 370 |
| 5 | 87 | 121 | 36 | 179 |
| 6 | 201 | 62 | 38 | 60 |

As can be seen, the Charpy impact strength at −253° C. for all alloys is above 27 J/cm². This is unusually high for a cast steel. Alloys 1, 2 and 3 in particular show Charpy impact strength at −253° C. of around 100 J/cm² or 60 J/cm². These values are well above the required minimum value of 27 J/cm². Molded parts produced from these alloys therefore have a sufficient safety margin with regard to the Charpy impact strength and a long service life.

As is to be expected, Table 2 also shows that the Charpy impact strength decreases with temperature. Only for Alloy 5, which has a particularly low Charpy impact strength at 20° C., does the Charpy impact strength initially increase at −196° C. and then drops sharply to −253° C. It can also be seen from Table 2 that the corresponding forged steel from the same alloy has a higher Charpy impact strength at −253° C. This corresponds to the behavior of conventional steel.

Table 3 shows further mechanical properties of molded parts according to the invention. All values were measured at 20° C.

TABLE 3
Tensile strength, elongation at break, ductility

| | Yield | Tensile | Elongation at | Reduction in |
|---|---|---|---|---|
| | strength | strength | break | area |
| Alloy No. | [N/mm²] | [N/mm²] | [%] | [%] |
| 1 | 148 | 330 | 52.1 | 43.8 |
| 2 | 183 | 417 | 44.7 | 39.9 |
| 3 | 157 | 193 | 13.4 | 16.4 |
| 4 | 194 | 462 | 57.2 | 29.5 |
| 5 | 212 | 421 | 36.1 | 13.9 |
| 6 | 307 | 549 | 23.7 | 24.5 |

What is claimed is:

1. A method of producing a molded part, the method comprising:
(a) melting an alloy consisting of:

| | | | |
|---|---|---|---|
| Si: | 2.50 | to | 4.50%, |
| Cr: | 10.50 | to | 19.00%, |
| Ni: | 13.50 | to | 20.00%, |
| Mn: | 0.50 | to | 1.50%, |
| Co: | 1.00 | to | 2.00%, |
| Mo: | 0.50 | to | 1.50%, |

wherein the rest is iron and inevitable impurities, and the contents of C, P, S and Cu as inevitable impurities are as follows:
C: not more than 0.050%,
P: not more than 0.030%,
S: not more than 0.030%,
Cu: not more than 1.50%,
where all quantities are given in percent by weight based on the total mass of the alloy;
(b) pouring the melt into a mold to produce a molded part; and
(c) subsequently carrying out a solution heat treatment of the molded part at a temperature in the range of from 950° C. to 1150° C.

2. The method according to claim 1, characterized in that the alloy has the following composition:

| | | | |
|---|---|---|---|
| Si: | 2.50 | to | 3.50%, |
| Cr: | 10.50 | to | 19.00%, |
| Ni: | 13.50 | to | 20.00%, |
| Mn: | 0.50 | to | 1.50%, |
| Co: | 1.00 | to | 2.00%, |
| Mo: | 0.50 | to | 1.50%, |

wherein the rest is iron and inevitable impurities, and the contents of C, P, S and Cu as inevitable impurities are as follows:
C: not more than 0.050%,
P: not more than 0.030%,
S: not more than 0.030% and
Cu: not more than 1.50%.

3. The method according to claim 1, characterized in that the solution heat treatment is carried out at a temperature in the range of from 1050 to 1150° C.

4. The method according to claim 2, characterized in that the solution heat treatment is carried out at a temperature in the range of from 1050 to 1150° C.

5. The method according to claim 1, characterized in that the molded part is selected from the group consisting of valves, parts of valves, pumps, parts of pumps, turbines, parts of turbines, fittings, parts of fittings, pipes, distributors, connecting pieces, bolts, screws, and nuts.

6. The method according to claim 2, characterized in that the molded parts are selected from the group consisting of valves, parts of valves, pumps, parts of pumps, turbines, parts of turbines, fittings, parts of fittings, pipes, distributors, connecting pieces, bolts, screws, and nuts.

7. The method according to claim 5, characterized in that the molded parts have a fracture toughness enabling the molded parts to be used for storing, transporting, or processing liquid hydrogen.

8. The method according to claim 6, characterized in that the molded parts have a fracture toughness enabling the molded parts to be used for storing, transporting, or processing liquid hydrogen.

9. The method according to claim 1, characterized in that the alloy of the molded part has a nickel equivalent yH of at least 24%, where the nickel equivalent is calculated according to the formula (1):
yH=0.35*Si (%)+0.65*Cr (%)+1.0*Ni (%)+1.05*Mn (%)+0.98*Mo (%)+12.6*C (%), (1)
where Si (%), Cr (%), Ni (%), Mn (%), Mo (%) and C (%) mean the content of these elements in the alloy in percent by weight, based in each case on the total amount of the alloy.

10. The method according to claim 1, characterized in that the composition of the alloy of the molded part obeys the following conditions:
Nieq>=25.40−0.80*Creq, (2)
Nieq>=−8.48+1.03*Creq, (3)
where Nieq is a nickel equivalent and Creq is a chromium equivalent and Nieq and Creq are defined according to the following equations:
Nieq=Ni (%)+30*C (%)+0.5*Mn (%)+0.1*Co (%), (4)
Creq=Cr (%)+0.3*Mo (%)+1.5*Si (%)+0.5*Nb (%), (5)
where Ni (%), C (%), Mn (%), Co (%), Cr (%), Mo (%), Si (%) and Nb (%) the content of these elements in the alloy in percent by weight, each based on the total amount of the alloy.

11. The method according to claim 1, characterized in that the alloy of the molded part has a Charpy impact strength of at least 27 J/cm², the Charpy impact strength being measured according to JIS Z 2242 and at a temperature of −253° C., with a rectangular cuboid test specimen with a height and width of 10 mm and a V-shaped notch of 2 mm.

12. A molded part produced by the method according to claim 1.

13. A molded part produced by the method according to claim 2.

14. A valve comprising a molded part according to claim 12.

15. A valve comprising a molded part according to claim 13.

16. A filling station for supplying motor vehicles with liquid hydrogen, comprising a molded part according to claim 12.

17. A molded part according to claim 12, characterized in that the alloy of the molded part has a Charpy impact strength of at least 27 J/cm², the Charpy impact strength being measured according to JIS Z 2242 and at a temperature of −253° C., with a rectangular cuboid test specimen with a height and width of 10 mm and a V-shaped notch of 2 mm.

18. A molded part according to claim 13, characterized in that the alloy of the molded part has a Charpy impact strength of at least 27 J/cm², the Charpy impact strength being measured according to JIS Z 2242 and at a temperature of −253° C., with a rectangular cuboid test specimen with a height and width of 10 mm and a V-shaped notch of 2 mm.

19. A valve according to claim 14, characterized in that the alloy of the molded part has a Charpy impact strength of at least 27 J/cm², the Charpy impact strength being measured according to JIS Z 2242 and at a temperature of −253° C., with a rectangular cuboid test specimen with a height and width of 10 mm and a V-shaped notch of 2 mm.

20. A valve according to claim 15, characterized in that the alloy of the molded part has a Charpy impact strength of at least 27 J/cm², the Charpy impact strength being measured according to JIS Z 2242 and at a temperature of −253° C., with a rectangular cuboid test specimen with a height and width of 10 mm and a V-shaped notch of 2 mm.
